(19) United States
(12) Patent Application Publication
(10) Pub. No.: US 2016/0262339 A1
(43) Pub. Date: Sep. 15, 2016

(54) LARGE-SCALE BUILDING WITH NATURAL VENTILATION

(71) Applicant: Swan Hill Engineering Pty Ltd, Swan Hill (AU)

(72) Inventor: Joseph Crisp, Swan Hill (AU)

(21) Appl. No.: 15/018,610

(22) Filed: Feb. 8, 2016

(30) Foreign Application Priority Data
Feb. 6, 2015 (AU) 2015100133

(51) Int. Cl. A01K 1/00; E04D 13/17; E04H 5/08; E04B 7/08

(52) U.S. Cl. CPC A01K 1/0058; E04B 7/08; E04D 13/174; E04H 5/08; A01K 1/0064

(57) ABSTRACT

The livestock shed has parallel rows of stanchions rising from a concrete base and a metal roof that is built in two halves that are separated by a central air gap. Each roof half has an inclined center strip defining one half of the gap edge. The roof portion is generally concave. The resulting shed is of correspondingly low profile while still exerting good ventilation. In capped versions, the gap is surmounted by a convex roof cap spaced above the gap in order to allow ventilation while excluding precipitation.

### PRIORITY CLAIM

This application claims the benefit of the filing date of Australian Patent Application Serial No. 2015100133 A4, filed Feb. 6, 2015, for “Natural Ventilation Livestock Shed,” the disclosure of which is hereby incorporated herein in its entirety by this reference.

### TECHNICAL FIELD

This disclosure relates to large-scale buildings. More particularly, this disclosure relates to large-scale buildings with natural ventilation. Still more particularly, this disclosure relates to large-scale sheds with natural ventilation made especially for sheltering livestock, including ruminants such as cattle, sheep, camels and goats, and non-ruminants, such as equine and porcine animals, and bird livestock, such as chickens and turkeys.

### BACKGROUND

The following references to and descriptions of prior proposals or products are not intended to be, and are not to be construed as, statements or admissions of common general knowledge in the art. In particular, the following prior art discussion does not relate to what is commonly or well known by the person skilled in the art, but assists in the understanding of the inventive step of the present disclosure of which the identification of pertinent prior art proposals is but one part.

Stanchion type sheds should shed rain efficiently from the roof and promote ventilation. The passage of livestock, such as cattle, through the shed generates manure or other droppings, and while there may be equipment that disposes of this waste, the ammonia and hydrogen sulphide released by the waste may deleteriously affect both the livestock and the staff. The release of air from the shed and its replacement by incoming air should be uninterrupted irrespective of the weather, which may otherwise act to interfere with the flow.

Likewise, a shed roof may absorb large amounts of heat through solar radiation daily. The heat may radiate to the air above and below the roof While the air above the roof is free to convect heat into the ambient surroundings, it is desirable that the air beneath the roof in the interior spaces of the shed should not heat up unduly or the livestock's condition and the staff's productivity may be adversely affected.

It is considered by some that shed roof design should be restricted for the efficient drainage of rainwater to a gradient for which the optimal inclination is between 23 and 30 degrees. If a wide shed is required where the pitch extends a relatively long distance from a ridge, the height of the shed may exceed permissible limits in farm surroundings or may present excessive wind resistance, as well as attendant cost factors. By corollary, if the shed roof is too low, there may be a problem of an undesirable heat build-up in the shed's interior when the ambient temperature is high.

An object of this disclosure is to ameliorate the aforementioned disadvantages of the prior art or to at least provide a useful alternative thereto.

### BRIEF SUMMARY

The disclosure according to one or more aspects is as defined in the independent claims. Some optional and/or preferred features of the disclosure are defined in the dependent claims.

Accordingly, in one aspect of the disclosure there is provided a shed with a roof supported by columns or stanchions and covering an interior, wherein the roof comprises at least two roof sections, including a first section and a second section, the roof sections extending between a central region outwardly toward a perimeter region, the central region having a ridge portion including at least one gap that allows ventilation for the interior, each roof section being substantially concave from above and increasing in height from the perimeter region to the central region.

Stanchion sheds are advantageously employed to tightly but comfortably restrain livestock by use of the stanchions as structures to contain livestock, such as cattle. The stanchions may be closely spaced and arranged in rows under and supporting the roof. The stanchions may comprise at least two spaced rows extending along the perimeter region of each side of the shed. The stanchions may include one or more central rows of stanchions, to provide additional support and controlled accommodation for the livestock. The stanchions may be in the form of vertical posts. The stanchions may be supported by foundations. The stanchions may be supported by a base plate. The rows of stanchions may be supported by one or more piers. The foundations may comprise concrete set below ground level.

The shed may be a structure for housing or protecting livestock. The shed may include enclosing walls or may be an open structure with partially or fully open sides and/or ends. For the purposes of this specification, the walls mean the peripheral sides and ends of the shed, whether they are open, partially open, or closed. Open or partially open walls may comprise a series of substantially vertical posts optionally braced with lateral horizontal or inclined beams. Closed or partially closed walls may comprise panels or other wall barriers extending across or between the posts. For ventilation purposes, the walls are preferably at least partially open to draw air in from the sides and/or ends of the shed.

The walls may be inclined to the vertical. The walls may be outwardly inclined to provide a counter-supporting force for the peripheral portion of each roof section. Alternatively, the exterior walls may be inwardly inclined from their respective bases to their upper extent. Preferably, the walls are aligned substantially vertically, for example, being aligned in a substantially vertical plane. The walls may terminate and join the roof directly or indirectly. The walls may stand at a height substantially between about one-third to about one-half of the height of the inner stanchions, and preferably between about 40% and 45% of the height of the inner stanchions. Accordingly, the disclosure may achieve a shed height profile that is low to minimize exposure to wind gusts and achieve a smaller interior space, relative to a flat or convex profiled roof.

Preferably, the gap is covered by a roof cap spaced from the roof to allow ventilation and exclude precipitation. It is feasible, however, to exclude the cap, so that is merely an optional, if desirable, feature. If the shed has no cap, for example, to reduce wind resistance, rain falls through the gap into the shed's interior, but a flushing drain may be sited or positioned directly beneath the gap to capture fallen precipitation so that the ingress of rain is not a problem.

The perimeter of the arcuate or curved roof may adjoin a roof extension along one edge of the roof. The roof extension may be curved in profile. The roof extension may be cantilevered and supported from centrally located or perimeter-located rows of stanchions.

The roof extension may be flat. The roof extension may be inclined. The roof extension may extend outwardly from the curved roof area from an extremity of the roof, including a side or end. The roof extension may extend inwardly. The roof extension may provide a bridge or span between the inner periphery of the curved roof structure and the gap. The roof extension may provide a corridor along one side edge of the shed. The roof extension may cover a central area of the shed. The shed may have a pair of side roof extensions, each extending along a side edge of the shed.

The side roof extensions may each correspond to a proportion of about 5%-15%, more preferably about 8%-13%, and most preferably about 10%-12%, of the width of the shed. The central roof extension may comprise a pair of central roof extensions. The central roof extensions may be supported by cantilevered beams. The central roof extensions may comprise a pair of parallel and adjacent roof extensions, each extending from the curved roof section and joining at a central portion. The central portion may correspond to the location of the gap. The central roof extension may correspond to a proportion of about 5%-25%, more preferably about 12%-22%, still more preferably about 15%-20%, and most preferably about 17%-18%, of the width of the shed.

The roof covering may include sheet metal. The sheet metal may be corrosion resistant. The sheet metal may have a corrugated or channel profile. The sheet metal may be galvanized iron, or zinc-coated steel.

The gap is preferably about 1%-4%, preferably about 2%-3%, and most preferably about 2.2%-2.6%, of the shed width. The sizing of the gap width is advantageously large enough to promote draft of air flow through the shed interior. The gap width is preferably sized to present a small enough gap to be adequately covered by the cap or to present a small opening through which minimal weather ingress, such as by dust, debris and precipitation, can occur.

The concavity of the curved roof section may be such that the width-to-rise ratio is about 1000:100-1000:400, and preferably about 1000:200-1000:300.

The concavity of the roof is preferably such that the width-to-rise ratio is 1000:200-1000:300.

### Advantageous Effects of Disclosure

1. Sun protection combined with ventilation and adequate roof slope for run off.

2. Economy of structure.

3. Freedom of floor planning.

4. Low overall height for a given floor area.

### BRIEF DESCRIPTION OF THE DRAWINGS

The disclosure is now described in the following non-limiting description of preferred embodiments with reference to the accompanying drawings, in which:

FIG. 1 is an end elevation of a shed made according to a first embodiment of the disclosure;

FIGS. 2a and 2b are, respectively, full and partial inner perspective views of the shed shown in FIG. 1;

FIGS. 3a and 3b are upper perspective views of the shed shown in FIG. 1;

FIGS. 4a and 4b are side perspective views of the shed shown in FIG. 1;

FIG. 5 is a perspective view of a fragment of the end of a shed according to a second embodiment showing a central row of stanchions and a ventilation cap.

FIG. 6 is a side elevation of a third embodiment of a shed made according to the disclosure;

FIGS. 7a-7c are partial sectional side elevations of various components of the roof of the shed shown in FIG. 6;

FIG. 7d is a partial sectional side elevation of a stanchion footing of the shed shown in FIG. 6;

FIG. 8 is a sectional side elevation of a fourth embodiment of shed made according to the disclosure, including the structure of the shed of the second embodiment with additional cantilevered side roof extensions; and

FIG. 9 is a sectional side elevation of a fifth embodiment of shed made according to the disclosure, including the structure of the shed of the second embodiment with additional side corridor extensions.

### DETAILED DESCRIPTION

Preferred features of the present disclosure will now be described with particular reference to the accompanying drawings. However, it is to be understood that the features illustrated in and described with reference to the drawings are not to be construed as limiting on the scope of the disclosure, except as may be recited in the claims accompanying this specification.

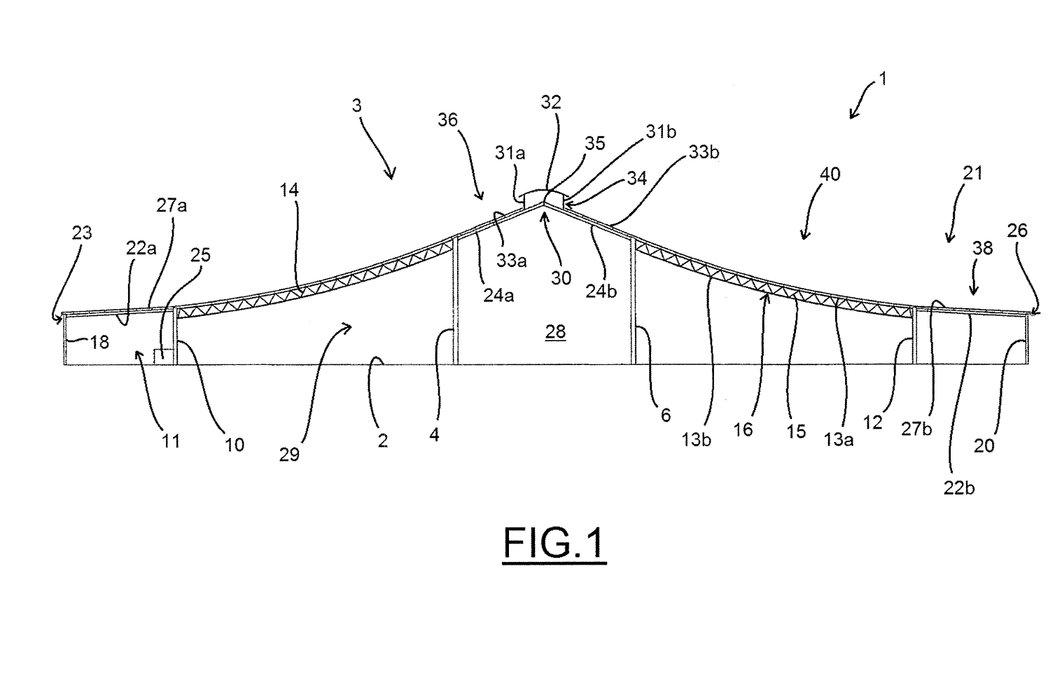

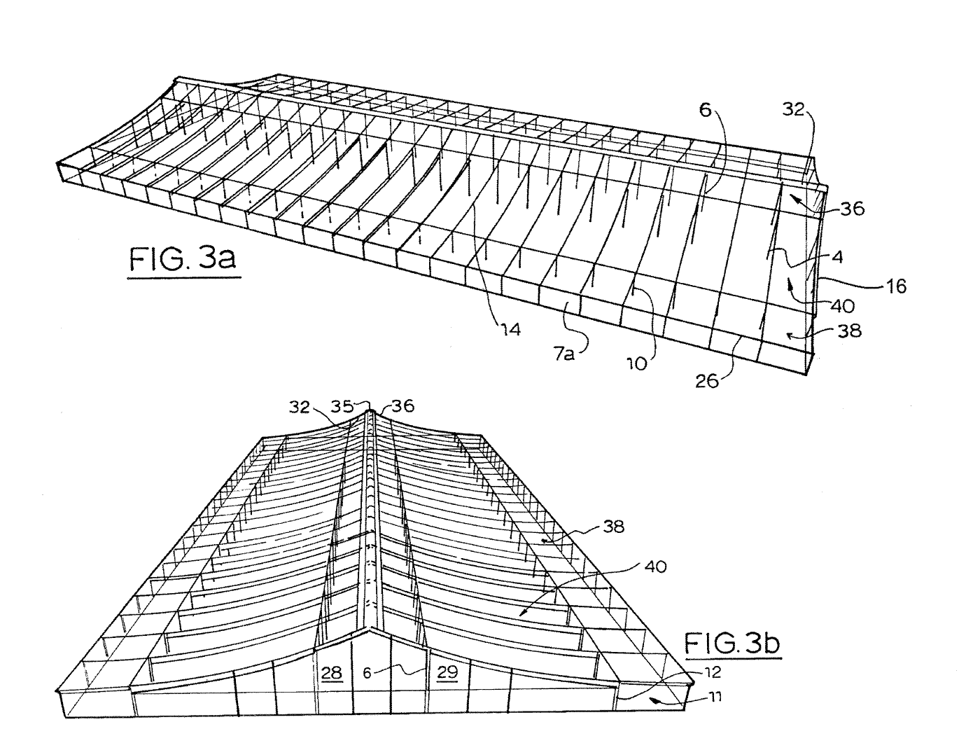

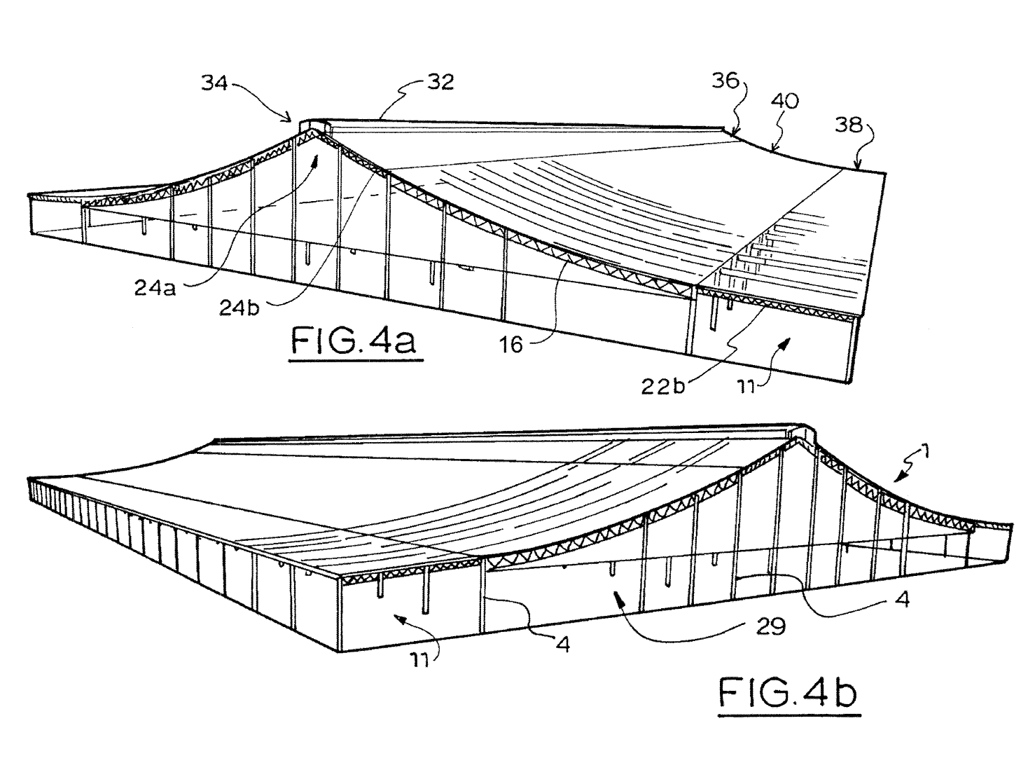

Referring to the FIGS. 1-4, a shed 1 is shown in end elevation and includes a shed base or ground surface 2, a roof 3, sides 7a and ends 7b, all defining an internal space 29.

The base 2 is laid out to accommodate the stalls, equipment, communicating pathways and travel pathways for livestock such as cows, personnel and vehicles. Inner pairs of rows of stanchions 4, 6 are erected in central axial rows. These stanchions 4, 6 are about 15-20 m apart across the width of the shed.

Outer pairs of rows of stanchions 10, 12 are erected in two outer rows about 25-30 m from the central inner rows of stanchions 4, 6. The inner stanchions 4, 6 are about 10-15 m, and preferably about 12-13 m, in height from the base 2. The outer stanchions 10, 12 are about 4.5-6.5 m, and preferably about 5-6 m, in height from the base or ground surface 2.

The outer and inner rows of stanchions 4, 6, 10, 12 are spanned by curved steel beams 14, 16 that are about 25-30 m long and formed from upper and lower chords 13a, 13b spanned by interposing braces 15 arranged in z-formation. The curved steel beams 14, 16 are concave in order to support a roof profile across the roof span 40 in which the pitch increases or deepens from its side periphery 21 toward the shed's 1 center extending along the mid axis 35.

A perimeter row of stanchions 18 run parallel to the outer row 10 and a like perimeter row of stanchions 20 runs parallel to the outer row 12 along the side length of the shed 1.

The outer stanchion rows 10, 12 and perimeter stanchion rows 18, 20 are separated or spaced laterally across the shed's 1 width by a distance of about 10 m-12 m, and these outer strips 38 of the shed roof 3 are spanned by straight beams 22a, 22b. The purpose of these portions of the roof 3 comprising the outer strips 38 is to form side eaves 23, which include gutters 26 and down pipes (not shown) and to provide a covered lane or corridor 11 lined with feed mangers 25.

The central area 28 between the pairs of rows of inner stanchions 4, 6 is about 15 m-12 m wide and this space 28 is spanned by cantilever beams 24a, 24b projecting inwardly from the concave or curved beams 14, 16 to which they are bolted. The cantilever beams 24a, 24b intersect along the mid axis 35 of the roof 3 and support a ventilation gap 30 covered by a convex (from above) sheet metal roof cap 32 and having open sides 34.

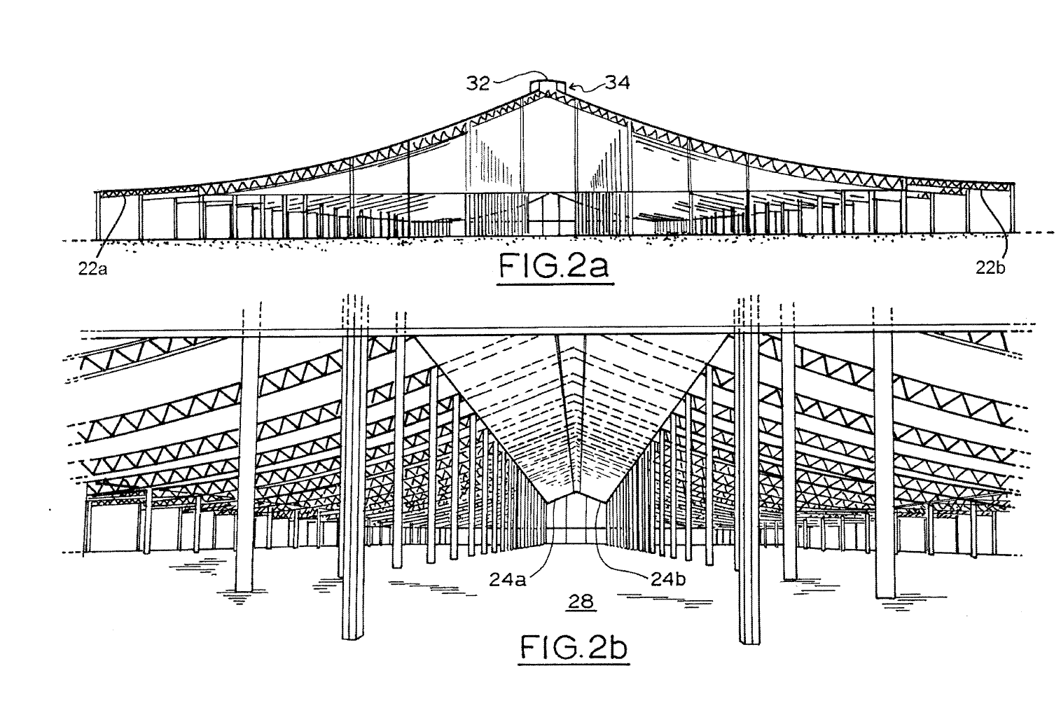

The cap 32 is vertically spaced from the central beams 24a, 24b by a pair of rows of posts 31a, 31b mounted to a central upper portion of each central cantilever beam 24a, 24b as shown in FIG. 2, noting that only the first pair of posts 31a, 31b is shown for clarity. As shown in FIG. 2, the central straight cantilever beams 24a, 24b are advantageously formed from a pair of upper and lower chords supported and spaced from each other by interposed braces in Z-formation to provide relatively lightweight beams 24a, 24b extending over the central area 28.

The roof 3 begins at the open sides 34 and is made of overlapping sheets of zinc coated corrugated steel sheets 33a, 33b of a roof portion 36. The opposing central roof sheets 33a, 33b do not join but define the gap 30, which is intermittently crossed by the cantilevered beams 24a, 24b. The central roof portions 36 meeting the concave mid-section 40 and overlying the cantilever beams 24a, 24b, and the outer beams 22a, 22b supporting a peripheral roof portion 38 foaming the shed eaves 23, are straight or linear. Accordingly, the inner and outer roof sections 36, 38 are substantially flat or substantially planar.

The roof cap 32 is optimally set at a height of about 16 m from the base 2 and is raised about 1 m-1.5 m, and preferably about 1.2 m-1.3 m, and most optimally about 1220mm, above the peak of the central cantilever beams 24a, 24b. The gap 30 between the roof portions 36 covered by the central roof sheets 33a, 33b is about 2 m-3 m, and more preferably about 2.3 m-2.6 m, and most optimally about 2.4 m wide. How quickly the convex curve of a roof truss rises or how “tight” the curve is will be expressed in terms of radius. The concave mid-section 40 of the roof 3 has a radius of curvature that exhibits a rise of about 100 mm-300 mm per meter, more preferably about 140 mm-260 mm per meter, still more preferably about 200 mm-250 mm per meter and most preferably about 248 mm per meter.

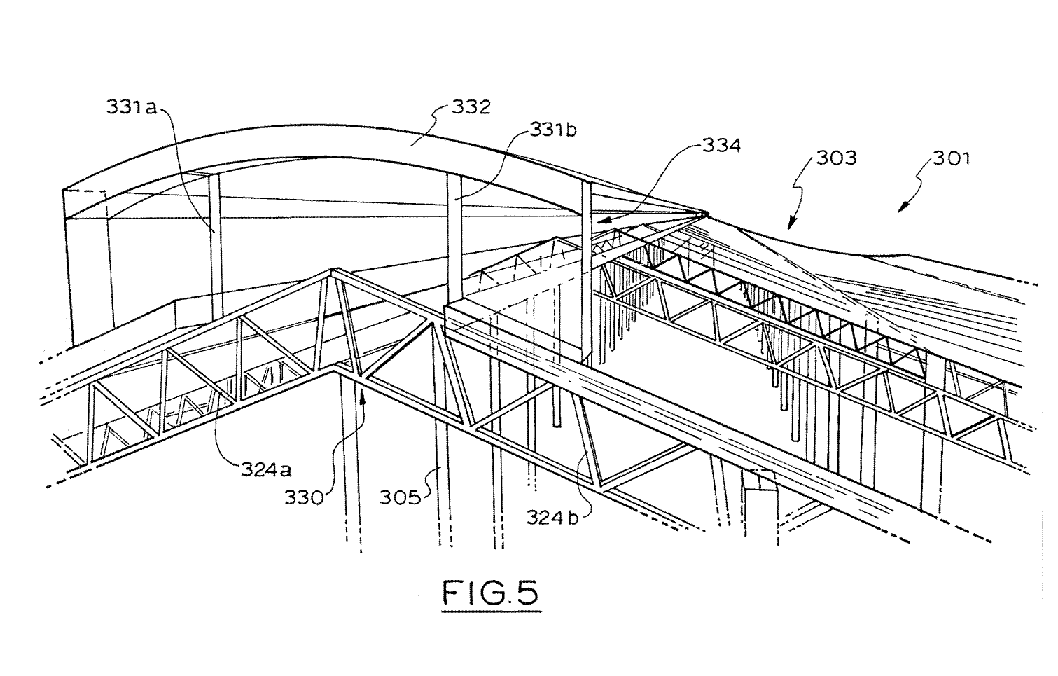

In FIG. 5, a shed 301 according to a second embodiment of the disclosure is shown having a row of central stanchions 305 that support the centrally joined purlins 324a, 324b abutting the location of a ventilation gap 330, 334. The shed 301 has a central cap 332 above the gap 330, 334 that is supported by a pair of rows of vertical posts 331a, 331b extending substantially the length of the shed's 301 roof 303.

In the remaining drawings, like features will be referred to using like reference numerals in the 100's relative to the first embodiment and the other embodiments described in this specification. Where appropriate, dimensions have been indicated in the drawings to best exemplify the dimensions and ratios of the preferred embodiments.

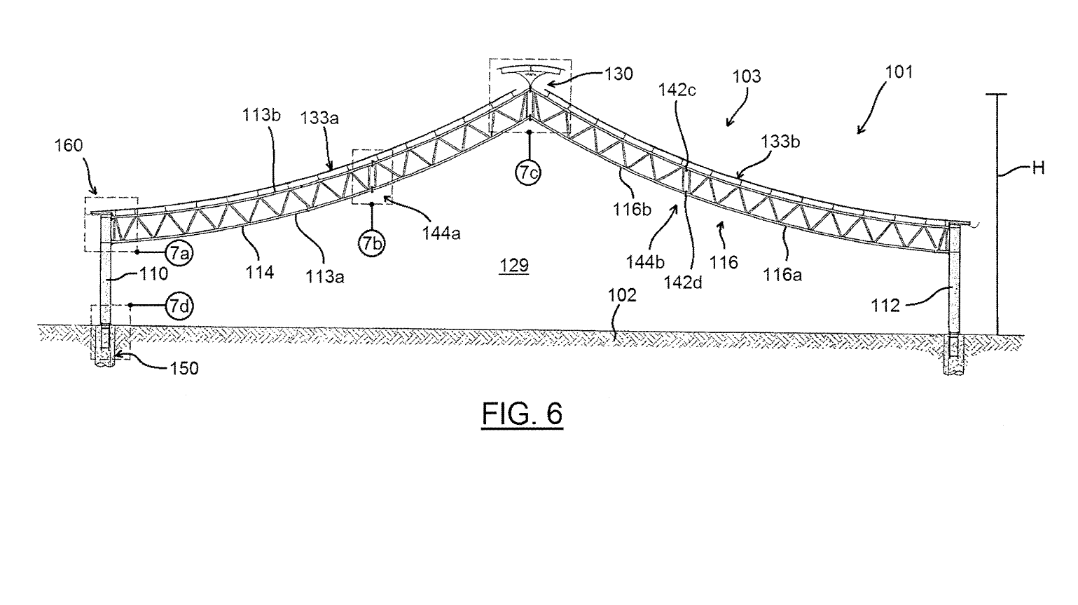

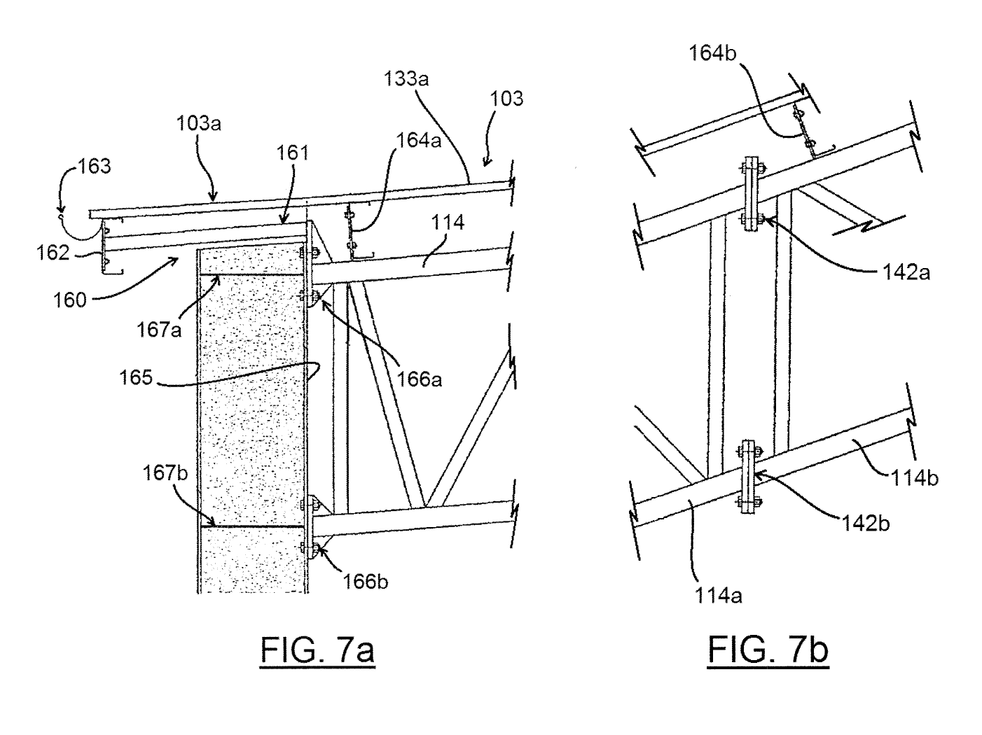

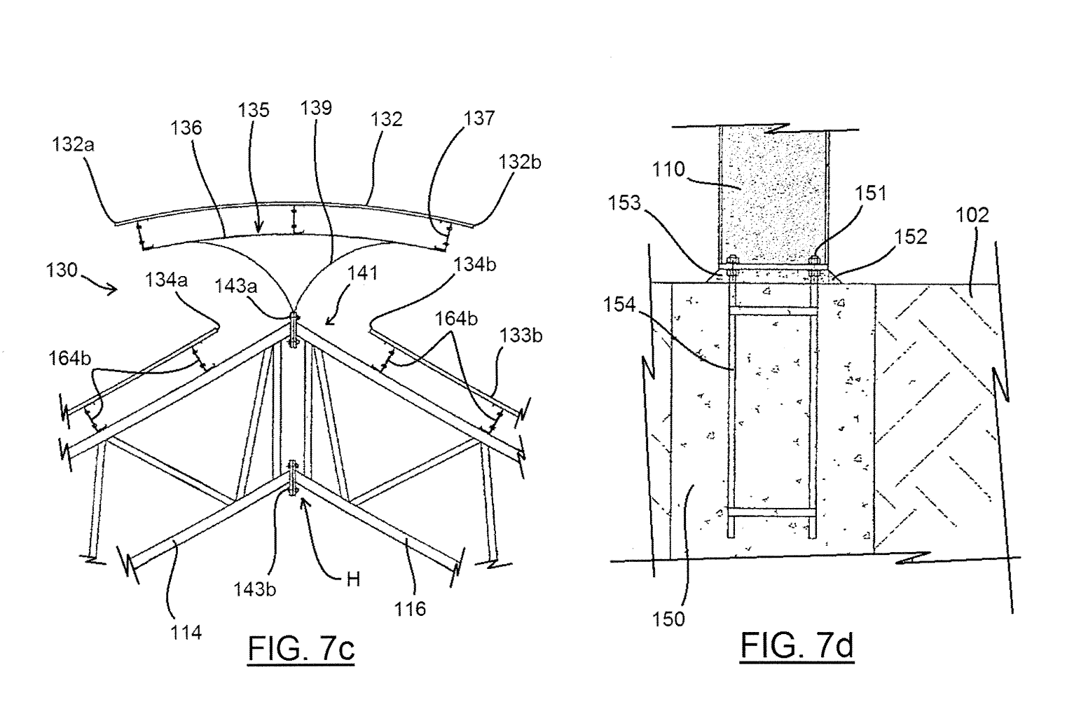

Referring to FIGS. 6-7d, a third embodiment of the disclosure is shown in the form of a shed 101. The shed 101 comprises a shed having a lineal horizontal span of a roof 103 of about 30 m-35 m covering an interior space 129.

The shed 101 structure is supported by a pair of side rows of columns or stanchions 110, 112 made of H.D. galvanized steel and about 4 m in height and about 350 mm-410 mm in square section. The stanchions 110, 112 may be founded in a variety of ways depending on the constraints of the site and the particular loads and soil/ground types, such as rock, clay, sand, loam, etc. For structures having a high load through the stanchions and unstable soil/ground types, the stanchions 110, 112 may be founded in deep foundations 150 best shown in FIG. 7d about 750 mm square and 1200 mm deep packed with concrete packed at 20 mPa. The base of the stanchions 110, 112 may be mounted to a horizontal square base plate 152 with tapered edges 153 through bolts 151 to a reinforcing pier frame 154 about 300 mm in width depending vertically about 1 m into the concrete foundation 150.

As best shown in FIG. 7a, each stanchion's 110, 112 upper terminal end 160 is slightly inclined to follow the tangent 103a of about 3 degrees to the horizontal of the outer extent of the roof 103. Attached to the internal side wall 165 of the upper end 160 is an eave and gutter outrigger bracket 161 that has an upstanding bracket 162 spaced outwardly from the stanchion 110, 112 to support the outer extremity of the roof 103. Attached to the upstanding bracket to catch run-off is a gutter 163.

Internal to the stanchion 110, 112 is a second upstanding bracket 164a mounted to a first curved purlin 114. Similar upstanding brackets 164b space zinc-plated roof cladding 133a, 133b from the purlins 114, 116 along their respective lengths. The first curved purlin 114 is mounted to the upper internal wall 165 by a pair of vertically spaced haunch plates 166a, 166b. The stanchion 110, 112 is internally reinforced at the heights corresponding to the placement of haunch plates 166a, 166b by substantially horizontal column stiffener plates, bars or braces 167a, 167b.

The curved purlin 114 extends laterally inwardly and upwardly in a concave contour from above to a peak height H of about 8 m-9 m, where each inner end is joined to its opposed member purlin 116 of its pair to support each other and permit the structure to define an interior space 129 completely free of the need for vertical supports. Optionally, for large purlin 114, 116 spans as shown in this embodiment, each of the purlins 114, 116 may be formed from two or more curved lengths 114a, 114b, 116a, 116b, preferably having substantially the same radius of about 4 m-6 m, preferably about 5 m, and following the same contour of curvature. The radius of curvature of the large purlins 114, 116 may correspond to a rise of about 200 mm-250 mm per meter and most preferably about 250 mm per meter.

As best shown in FIG. 7b, the purlin sections 114a, 114b, 116a, 116b are joined together intermediate their lengths by opposed pairs of splice plates 142a-142d welded to the ends of upper and lower chords 113b, 113a of mid-sections 144a, 144b of the purlins 114, 116, respectively. Otherwise, along their respective lengths, the purlins 114, 116 are of similar design and construction as the purlins 14, 16 of the first embodiment.

The purlins 114, 116 are joined at their respective inner ends, as best shown in FIG. 7c, by a central pair of upper and lower splice places 143a, 143b, so that the purlin pairings 114, 116 are supported above the base 102 by the resistance to outward displacement of the side stanchions 110, 112 to form a bridging purlin structure. The peak or ridge of the shed 101 includes a central ventilation gap 130 defined by the inner edges 134a, 134b of the spaced roof cladding 133a, 133b. The shed's interior space 129 is protected from the ingress of weather and debris by a lightweight convex (from above) cap 132 extending substantially the full length of the roof 103 and comprises a shallow reinforcing frame 135 having lower rigid curved bars 136 spaced from the convex cap 132 and having substantially the same contour as the cap 132. The cap 132 sheeting may be curved to have a similar radius as the purlins 114, 116.

The rigid bars 136 may be spaced from the underside of the cap 132 by two to five, preferably three, substantially interposed upstanding brackets 137. Ideally, for the purposes of simplification of parts, the upstanding brackets 164a, 164b, 137 are identical in construction. Side edges 132a, 132b of the cap 132, therefore, curve shallowly downwardly and the outer lateral extent of the side edges 132a, 132b at rest is set at an angle of overhang of about 40 degrees to about 50 degrees, preferably 45 degrees, relative to the inner edges 134a, 134b of the roof sheets 133a, 133b. This overhang restricts or resists all but the most severe weather incursions while permitting adequate ventilation from the interior 129.

At each of the plurality of spaced purlin 114, 116 sites along the length of the roof ridge at its apex 141, the cap 132 and the supporting frame 135 are supported by a pair of ribbon bars 139 mounted to the upper central splice plate 143a and each respectively curving outwardly to form a substantially flat upper surface to be welded to the underside of the rigid bar 136. The fanning ribbon bars 139 are capable of some flexion with a view to withstanding metal fatigue and failure caused by wind gusts and other like forces.

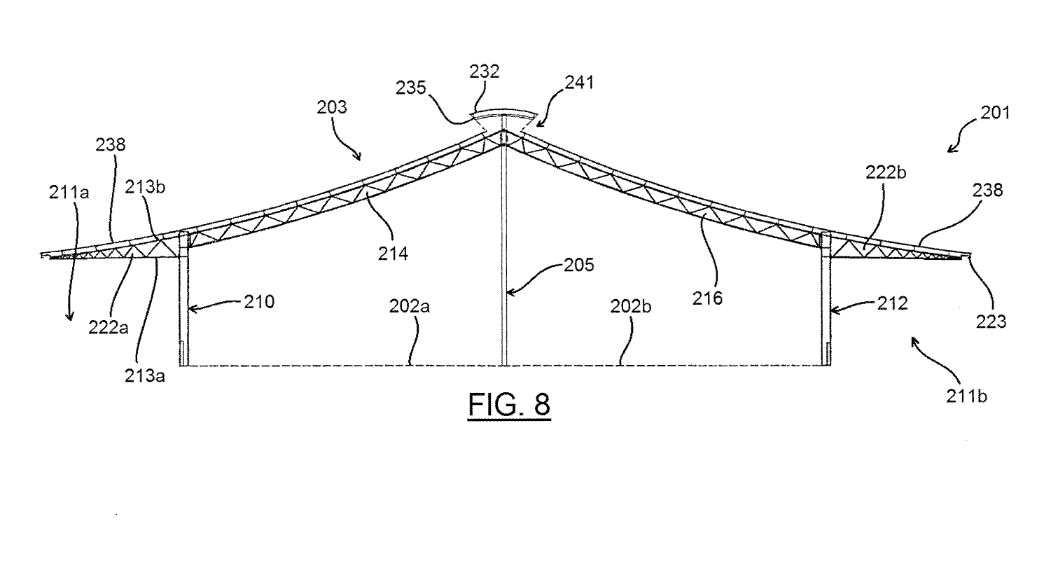

Turning to FIG. 8, a fourth embodiment of the disclosure is shown in the form of a shed 201 similar in structure to the second embodiment of the shed 301 and the third embodiment in the form of the shed 101. However, there are some significant differences between the sheds 101, 201.

The shed 201 includes side lanes 211a, 211b provided with the overhead protection of a veranda roof 238 that is supported by cantilevered extension beams 222a, 222b. The beams 222a, 222b continue the tangential curve of the main span of inner purlins 214, 216 and have cantilevered beams 222a, 222b with upper and lower chords 213b, 213a that converge from an inner end 221 in which the chords are spaced, to an outer end supporting eaves 223 at which the chords meet or converge to a spacing close to one another. The lanes 211a, 211b provide flush lanes adjacent the stanchions 210, 212 and feed lanes for livestock immediately under and within the cover of the eaves 223. The animals may each be tethered or secured to, or indirectly by use of the outer stanchions 210, 212, if desirable to restrain them.

Central to the shed 201 structure is a central row of stanchions 205 vertically supporting the shed roof 203 at its ridge or apex 241. Either side of the stanchions 205, loafing areas or pads 202a, 202b are provided within the line of stanchion rows 210, 212. The central row of stanchions 205 also supports a sub-frame 235 to, in turn, support an elongate cap 232 extending substantially the full length of the shed 201.

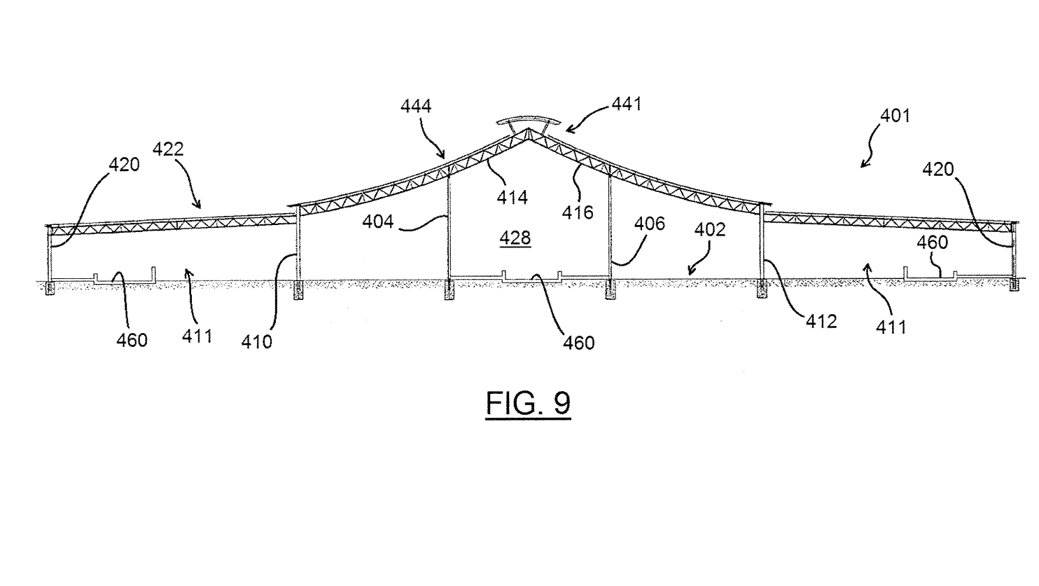

In FIG. 9 there is shown a loafing shelter shed 401 having a similar floor 402 layout to the shed 1, but a central apex 441 structure similar to the shed 101. Inner rows of stanchions 404, 406 are positioned to support the roof purlins 414, 416 intermediate their length and preferably support the purlins at spliced joints 444, if present in arrangements where the purlin span is large, such as purlin lineal spans greater than 15 m or where, prior to assembly, transport constraints require shorter length purlin components.

As with the shed 1, corridors 411 are provided by the attachment to the sides of the central shed structure of flat, low roof extensions 422 extending between outer rows of stanchions 410, 412 and perimeter rows of stanchions 420. Livestock treatment and feeding structures 460 are provided in the corridors 411 and the central loafing area 428.

It is to be understood that the word “comprising” as used throughout the specification is to be interpreted in its inclusive form, i.e., use of the word “comprising” does not exclude the addition of other elements.

In the present specification, terms such as “apparatus,” “means,” “device” and “member” may refer to singular or plural items and are terms intended to refer to a set of properties, functions or characteristics performed by one or more items or components having one or more parts. It is envisaged that where an “apparatus,” “means,” “device” or “member” or similar term is described as being a unitary object, then a functionally equivalent object having multiple components is considered to fall within the scope of the term, and similarly, where an “apparatus,” “assembly,” “means,” “device” or “member” is described as having multiple components, a functionally equivalent but unitary object is also considered to fall within the scope of the term, unless the contrary is expressly stated or the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the convex cap 32 uppermost. The shed 1 is a large elongate structure as illustrated in FIGS. 2a-4, and is generally longer than it is wide, in this embodiment having 25 stanchions 10, 12 in each row. However, its length is variable as it is substantially of consistent cross-section throughout its length and each set of lateral supporting and roofing components can be added to extend the shed 1 in the longitudinal direction parallel to the gap 30. In FIGS. 1, 6, 8 and 9, the sheds 1, 101, 201, 401 are shown in end elevation. Orientation of the sheds 1, 101, 201, 301, 401 is site specific and depends on the terrain and may be determined by specific engineering considerations in each case, but the sheds may be oriented in situ side on to the prevailing winds of a particular geographical landscape to achieve optimum ventilation.

It is to be understood that various modifications of and/or additions to the disclosure can be made without departing from the basic nature of the disclosure. These modifications and/or additions are, therefore, considered to fall within the scope of the disclosure.

1. A shed with a roof supported by columns or stanchions and covering an interior, wherein the roof comprises at least two roof sections, including a first section and a second section, the roof sections extending between a central region outwardly toward a perimeter region, the central region having a ridge portion including at least one gap that allows ventilation for the interior, each roof section being substantially concave from above and increasing in height from the perimeter region to the central region.

2. The shed as claimed in claim 1, wherein at least one of said roof sections is an arcuate roof and a perimeter of the arcuate roof adjoins a roof extension along one edge of the arcuate roof and the roof extension is flat and inclined.

3. The shed as claimed in claim 2, wherein the roof extension is a central roof extension that extends between the inner periphery of the arcuate roof and the gap.

4. The shed as claimed in claim 3, wherein the roof extension is a side extension that extends from a peripheral edge of the arcuate roof to the outer extremity of the roof.

5. The shed as claimed in claim 3, wherein the central roof extension comprises a pair of adjacent and joined roof extensions joined at the gap.

6. The shed as claimed in claim 4 wherein the roof extension comprises a pair of peripheral roof extensions spaced from each other and each extending along a side edge of the roof.

7. The shed as claimed in claim 1, wherein the concavity of the roof is such that the width-to-rise ratio is between 1000:100 and 1000:300.

8. The shed as claimed in claim 1. wherein the gap is covered by a roof cap spaced from the roof to define a ventilation opening.

9. The shed as claimed in claim 8, wherein the shed comprises one or more walls that are at least partially open to draw air in from the sides and/or ends of the shed.

10. The shed as claimed in claim 8, wherein the walls are aligned substantially vertically.

11. The shed as claimed in claim 1 wherein the stanchions include a plurality of inner stanchions in a row close to the gap and a plurality of outer stanchions in a row close to the peripheral edge of the shed.

12. The shed as claimed in claim 9, wherein the walls include side walls that stand at a height between about 40% and 45% of the height of the inner stanchions.

13. The shed as claimed in claim 4, wherein the side roof extension provides a corridor along one side edge of the shed.

14. The shed as claimed in claim 4, wherein the central roof extensions comprise a pair of parallel and adjacent roof extensions, each extending from the curved roof section and joining at a central portion, the central portion corresponding to the location of the gap and the central roof extension comprising a proportion of 15%-20% of the width of the shed.

15. The shed as claimed in claim 8, wherein the gap is about 2%-3% of the shed width and large enough to promote draft of air flow through the shed interior and small enough to be adequately covered by the cap.
